(19) United States
(12) Patent Application Publication
(10) Pub. No.: US 2007/0239599 A1
(43) Pub. Date: Oct. 11, 2007

(54) Sender pays receiver

(76) Inventor: Oleksandr Kizub, New Albany, OH (US)

Correspondence Address: OLEKSANDR KIZUB, 4511 CROOKED CEDAR DR., NEW ALBANY, OH, 43054, US

(21) Appl. No.: 11/278,427

(22) Filed: Apr. 2, 2006

(51) Int. Cl. G06Q 40/00

(52) U.S. Cl. 705/40

(57) ABSTRACT

Sender pays receiver for allowing of receiving information or using it in any way. Such approach inverts all kind of unwanted information like (but not limited to) spam or solicitation e-mails, telemarketers calls, bulk mail to wanted ones because it brings money for receiver. In other hand regular communications remain free because each side of dialog is dual sender and receiver in the communication process.

The receiver of information is paid by the sender for allowing of receiving information or using it in any way. Such approach diverts all kind of unwanted information like (but not limited to) spam or solicitation e-mails, telemarketers calls bulk mail to wanted ones because it requires sender to pay receiver. On the other hand regular conversation remain free because each side of dialog is dual sender and receiver in the conversation process.

### BACKGROUND OF THE INVENTION

The present invention defines a method of communication that diverts unwanted communications to very desired and wanted things.

Terms Definition:

Information is defined as anything that can be sent to the receiver. For example (but not limited to) e-mail, instant message, SMS, phone call, regular mail.

The information that the receiver wants to have or to use in any way is referred to as good information. Otherwise it is referred to as unwanted information.

Communication is process to sending and receiving information.

Conversation is set of communications between sides of communication back and forth.

The sender is defined as the side of communication which is actually sends information.

The receiver is defined as the side of communication which receives and uses the information sent by the sender.

Receiving is defined as the process of receiving information. It includes all steps of delivering, filtering and acceptance of sent information. Both the sender and the receiver participate in this process. The service providers serve as mediators by delivering the communications.

Since cost of producing and delivering information constitutes a very small part of communication process in comparison of the cost of using it then relations between information producers (senders) and information receivers should reflect this difference in cost.

The time has come to pay money to the side where actual expenses reside.

### SUMMARY OF THE INVENTION

The sender should pay the receiver for the ability to send him information and for the time the receiver spends looking over it. The receiver can filter all incoming information by setting a threshold amount of money that will be used to compensate the receiver for the time spent receiving and using this information. If receiver decides that received information (information contained in the given communication) is good, useful, worth something to him and conversation should continue, then the money the sender paid him in the first place could be used to pay for the reply. In this case, the money could just stay in the sender's account, as this same amount of money will be used up in order for the reply to pass sender's filter. Thus, regular conversation where both sides have an interest in participating will stay free, whereas unwanted communication will bring money in for the side that spends time and effort upon receiving it.

The general communication process will go something like this.

Anyone who is a potential receiver of information establishes an account and informs the service provider about any details pertaining to it. Ideally, the account should be set up through the service provider. Alternatively, it could be set up through a third party. Before or during receiving process receiver or service provider should determine who is sender and recognize pair of communication sides. It is sender-receiver pair. Whoever does actual receiving should verify that either receiver or sender have valid account and this account has deposited money for this particular sender-receiver pair and amount of money associated with this pair. If it does exist and not locked and amount does pass filter amount then this particular amount is locked by receiver and communication continues to proceed. After that receiver decides is information good or not and, based on this or any other reason, could actually withdraw money or keep them locked or unlock and use them to pay for answer assuming that sender probably has filters too. All these steps could vary or skipped. For example, receiver could transfer money from senders account to own account or even withdraw them immediately. But mostly such actions are not necessary because later if receiver decides to keep conversation alive and answer to sender this money should go back through all these steps. Receiver became sender and should follow all these steps backward. So, it's much easier to lock money for this particular sender-receiver pair on senders account then wait, think, decide to answer, unlock money and use this already existing pair to pass sender's filter on the way back for the answer. Or withdraw money later. Or even not touch money at all. If money is not locked by any side of communication then it could withdraw any time by any side. If any side does not or cannot participate in such process then money simply continues to reside on other side and still belong and controlled by owner whoever it is.

All communications could be filtered by amount of paid money.

Filter works even before information received based on the headers of the communication. Since receiver knows who sends information all necessary operations such as verification of senders account and deposited money, lock them or even actual withdraw could be done before actual information received.

Both receiver and sender themselves could do all described functions or steps on their own side automatically or even manually.

If communication cannot be established because of not enough money to pass the filter then sender will have message like that “You should pay N amount of money for receiver only for receive your information. If receiver will decide that information is useful for receiver then you will have answer with money back to you. Required money should be deposited on your account associated with both your and receiver addresses. If you don't have own account then money could be deposited on receiver's account X for the same pair of addresses and could be withdrawn later if receiver answers you back or will not use these money.”

Described invention is absolutely compatible with current systems. Communication sides which do not want or cannot use advantage of described methods are simply treated like they pay zero and can withdraw zero money.

Also, receiver may use described invention even for other part which don't want or can't pay. Receiver should pay money for himself for incoming information for particular sender. In this way communication for this particular sender can pass receiver's filter when sender doesn't even know about such things at all. And, in this case, money still stay on the receiver account and communication is still free and advantage of using invented approach is still here too. Receivers just allow some special and particular senders to communicate with them for free and do not participate in or even know about existence of invented approach. In other hand anybody else who has no account deposit and so receiver's permission to communicate will be filtered out.

What is claimed is:

1) A Method of communication where the sender pays the recceiver for allowing the information to be received or used in any way.

2) A Method of associating a certain amount of money with each communication. The sender and the receiver may each have an account from which money can be withdrawn or where money can be deposited in casc of a particular communication. Such an account could be recongnized directly from service provider or from header of communication. Communication can start only if such account has a certain amount ot money assigned for opposite side of communication corresponding to account owner.

3) A Method of filtering incoming communication based on the amount of money paid by method 1 and associated by method 2.

4) Methods of working with accounts. These methods are available for both sides of communication and they are:
Validation of existing account and amount of money deposited on this account for opposite side of communication;
lock/unlock deposited money;
withdrawn (actually transfer to own account) deposited money when they are not locked by opposite side of communication.

5) Any kind of support for described above methods or using this idea by account keepers, communication supporters, verification/lock/unlock/withdrawn/deposit processors.
